(19) United States
(12) Patent Application Publication
(10) Pub. No.: US 2006/0259913 A1
(43) Pub. Date: Nov. 16, 2006

(54) Daemon assisted command execution

(76) Inventors: H. Michael Wenzel, Ft. Collins, CO (US); Donald F. Hopkins, Eaton, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/128,969

(22) Filed: May 13, 2005

(51) Int. Cl. G06F 3/00

(52) U.S. Cl. 719/318

(57) ABSTRACT

In one embodiment a method of executing a command in a computing system comprises receiving, at a message interface associated with a daemon executing on the computing system, a service request identifying a command for execution; in response to the service request, executing one or more executable files related to the command for execution; and returning an output resulting from executing one or more executable files related to the command for completing execution.

### TECHNICAL FIELD

This application relates to electronic computing, and more particularly to daemon assisted command execution.

### BACKGROUND

Some commands in computer programming languages are non-modular in the sense that the command structure is tied to one or more specific pieces of hardware, hardware configurations, file systems, volume managers or other kernel components. Non-modular commands limit the portability of computer programs across hardware platforms, thereby imposing additional time and expense in developing applications for use across multiple platforms, or in incorporating new hardware or kernel components into a computing system that includes non-modular commands.

### SUMMARY

In one embodiment a method of executing a command in a computing system comprises receiving, at a message interface associated with a daemon executing on the computing system, a service request identifying a command for execution; in response to the service request, executing one or more executable files related to the command for execution; and returning an output resulting from executing the one or more executable files related to the command for completing execution.

### BRIEF DESCRIPTION OF THE DRAWINGS

FIG. 1 is a schematic illustration of one embodiment of a computing system adapted to implement daemon assisted command execution.

FIG. 2 is a schematic illustration of one embodiment of a hierarchical file directory that may be used to facilitate daemon assisted command execution.

FIG. 3 is a flowchart illustrating operations in one embodiment of a computing system adapted to implement daemon assisted command execution.

FIG. 4a is a schematic illustration of one embodiment of a data packet that may be used to facilitate daemon assisted command execution.

FIG. 4b is a schematic illustration of one embodiment of a response packet.

FIG. 5 is a schematic illustration of an exemplary computing environment.

### DETAILED DESCRIPTION

Described herein are exemplary system and methods for daemon assisted command execution in a computer system. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

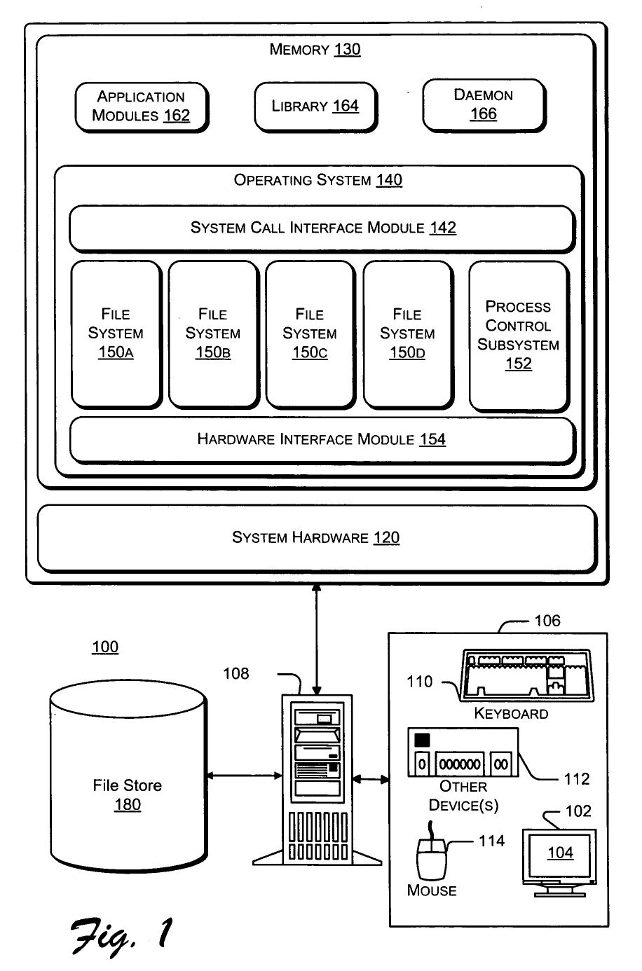

FIG. 1 is a schematic illustration of an exemplary computer system 100 adapted to perform daemon assisted command execution. The computer system 100 includes a computer 108 and one or more accompanying input/output devices 106 including a display 102 having a screen 104, a keyboard 110, other I/O device(s) 112, and a mouse 114. The other device(s) 112 can include a touch screen, a voice-activated input device, a track ball, and any other device that allows the system 100 to receive input from a developer and/or a user. The computer 108 includes system hardware 120 and random access memory and/or read-only memory 130. A file store 180 is communicatively connected to computer 108. File store 180 may be internal such as, e.g., one or more hard drives, or external such as, e.g., one or more external hard drives, network attached storage, or a separate storage network.

Memory 130 includes an operating system 140 for managing operations of computer 108. In one embodiment, operating system 140 includes a hardware interface module 154 that provides an interface to system hardware 120. In addition, operating system 140 includes one or more file systems 150A, 150B, 150C, 150D that managed files used in the operation of computer 108 and a process control subsystem 152 that manages processes executing on computer 108. Operating system 140 further includes a system call interface module 142 that provides an interface between the operating system 140 and one or more application modules 162 and/or libraries 164.

In operation, one or more application modules 162 and/or libraries 164 executing on computer 108 make calls to the system call interface module 142 to execute one or more commands on the computer's processor. The system call interface module 142 invokes the services of the file systems 150A-150D to manage the files required by the command(s) and the process control subsystem 152 to manage the process required by the command(s). The file system 150 and the process control subsystem 152, in turn, invoke the services of the hardware interface module 154 to interface with the system hardware 120.

The particular embodiment of operating system 140 is not critical to the subject matter described herein. Operating system 140 may be embodied as a UNIX operating system or any derivative thereof (e.g., Linux, Solaris, etc.) or as a Windows® brand operating system.

In one embodiment, commands and/or functions in command library 164 are modified to have any component instructions that are specific to particular hardware, hardware configurations, or file system(s) removed from the command structure and placed in a separate executable file, which may be stored in suitable data structure. By way of example, and not limitation, the UNIX function fstatvfsdev(fildes, buf) returns information about a file system on the device. The filedes parameter is a file descriptor for a device file. The buf parameter is a pointer to the statvfs structure, which is where the file status information is stored.

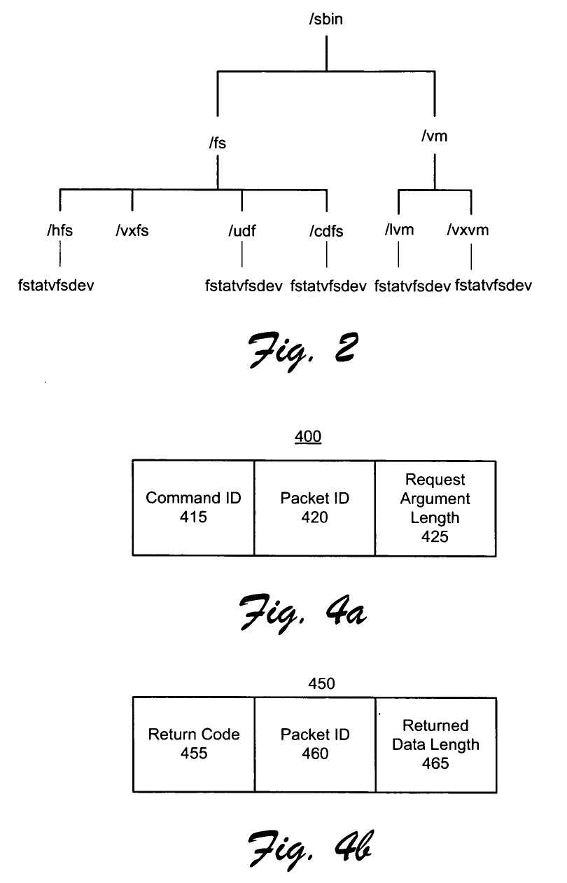

FIG. 2 is a schematic illustration of one embodiment of a file directory that may be used to facilitate daemon assisted command execution. Referring to FIG. 2, component instructions of the fstatvfsdev( ) function that are specific to hardware, hardware configuration, or a file system may be removed from command library 164 and stored in a hierarchical format in the UNIX/sbin directory that may be maintained in memory 130 of computer system 100 or in file store 180. Referring to FIG. 2, a hierarchical data structure may be constructed within the UNIX/sbin or other directory. The data structure depicted in FIG. 2 includes two branches: a file system branch (/fs) a volume manager branch (/vm). Each branch of the directory may include one or more subdirectories that identify, e.g., specific hardware products, configurations, file systems, volume managers, or other kernel components and the component instructions of the fstatvfsdev( ) function may be stored in the subdirectory. The fstatvfsdev( ) function is merely an exemplary function. The same technique may be applied to other commands and functions.

Referring back to FIG. 1, in one embodiment operating system 140 includes a daemon 166 that resides logically at the user level. Daemon 166 may be instantiated during the boot-up process of computer system 100. Daemon 166 receives service requests generated by one or more commands for execution, which may originate from a command interface or in the library 164. In response to the service request(s), daemon 166 locates and executes one or more executable files related to the command and returns the results generated by the one or more executable files to the command or library 164 for use in executing the command(s) that spawned the request. Details of the operation of computer system 100 and daemon 166 are described below.

FIG. 3 is a flowchart illustrating high-level operations in one embodiment of a method of daemon assisted command execution by computer system 100. Referring briefly to FIG. 3, at operation 310 the daemon 166 is instantiated. In one embodiment daemon 166 may be spawned by the init process at boot-up of computer system 100. Following instantiation, daemon 166 runs as a background process on computer system 100. When a user of computer system 100 or an application module 160 invokes a fstatvfsdev( ) function, command library 164 transmits a service request to daemon 166. In one embodiment, library 164 and daemon 166 may communicate using any interprocess communication method including, e.g., named streams, shared memory, pipes, FIFOs, or sockets.

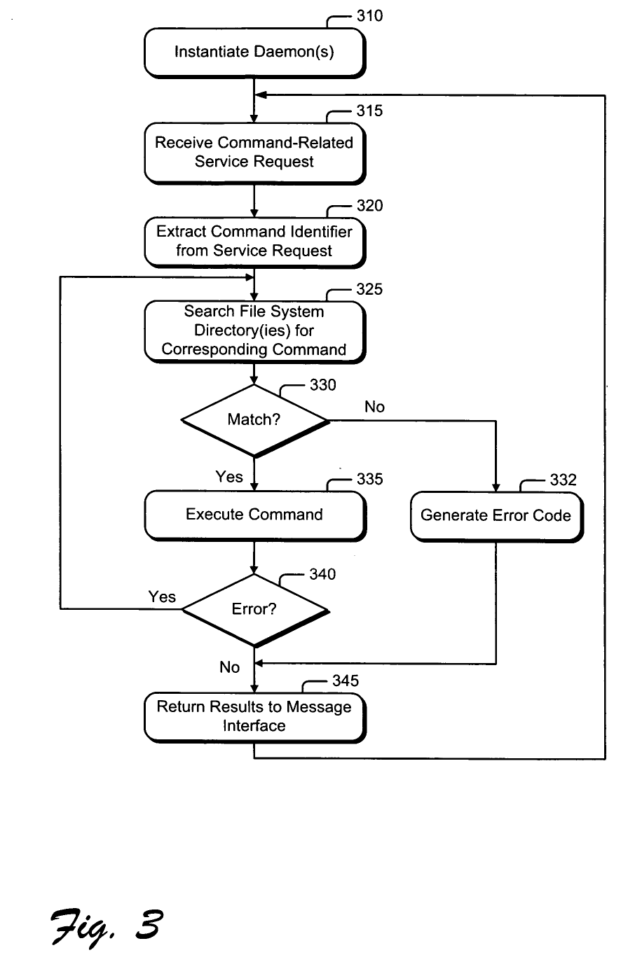

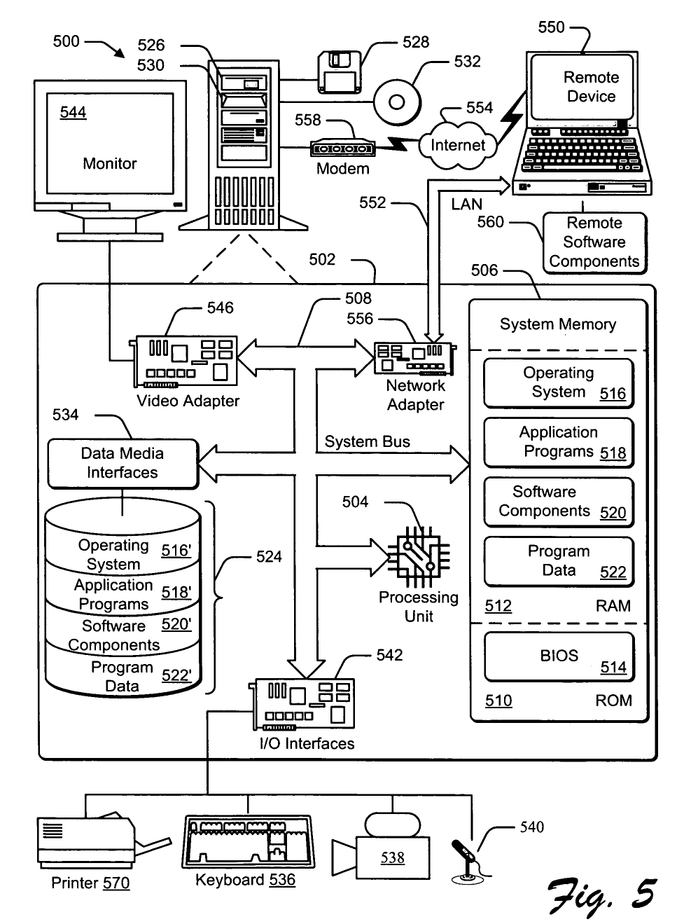

FIG. 4a is a schematic illustration of one embodiment of a data packet that may be used to facilitate daemon assisted command execution. In one embodiment, the service request transmitted from the command module 164 to daemon may be incorporated into a data packet as illustrated in FIG. 4. Referring briefly to FIG. 4a, data packet 400 comprises a command ID 415, a packet ID 420, and a request argument length field 425.

Command ID 415 includes an identifier that describes the command requested by the command library. Packet ID 420 is an identifier for the packet, and may be implemented as a cookie selected by the library 164. In addition, the packet ID may be used by the library or application to perform status checks on the request. The argument length field allows a variety of request argument structures to be passed through the connection to the daemon 166 without losing the position of the start of the next request. This may be useful in the event that multiple commands to the daemon share the same connection.

FIG. 4b is a schematic illustration of one embodiment of a response packet. Daemon 166 returns the requested data to the command interface or command library 164 using a response packet 450. Response packet 450 includes a return code 455, a packet ID 460, and a returned data length field 465. The packet ID460 permits the library 164 to correlate the response with the request.

Library 164 or application 162 may also transmit a file descriptor for the hardware device or file system to which the command applies. By way of example, for fstatvfsdevo this will be the file descriptor for the device file for which fstatvfsdev( ) information is desired. The file descriptor may be transmitted with the service request or in a subsequent data packet.

Referring back to FIG. 3, at operation 315 daemon 166 receives a command related service request, which may be embedded in a data packet depicted in FIG. 4. At operation 320 daemon 166 extracts the command identifier from the service request. At operation 325 daemon 166 searches the directory structure(s) for executable files having an identifier that corresponds to the command ID in the service request. If, at operation 330 no match is located in the directory, daemon 166 generates an error code which is transmitted to library 164 or to another program module, which may generate an indicator that no matching command was located, and control passes back to operation 315, where daemon waits to receive another command from library 164. By contrast, if at operation 330 a match is located than control passes to operation 335 and the command is executed. If, at operation 340, executing the command generates an error then control passes back to operation 325 and daemon continues to search. the directory for matching commands. By contrast, if executing the command does not generate an error then control passes to operation 345 and daemon 166 returns the results of the command execution to a message interface, from which the results are returned to the command or library 164.

By way of example, in the event that the service request includes a command ID for the fstatvfsdev( ) command. Referring briefly to the directory depicted in FIG. 2, daemon 166 traverses the hierarchical directory structure for fstatvfsdev( ) commands. When daemon 166 locates a fstatvfsdev( ) command, the command is executed using the file descriptor information provided from the command or library 164. When executing the fstatvfsdev( ) command results in an error, control passes back to operation 325 and daemon 166 continues to traverse the directory searching for additional fstatvfsdev( ) commands.

By contrast, when executing the fstatvfsdev( ) does not return an error, the fstatvfsdev( ) command will return the hardware-specific information required for library 164 to finish executing a corresponding fstatvfsdev( ) command. Daemon 166 returns the results of the fstatvfsdev( ) command execution to library 164 (e.g., by way of a message interface), so the library 164 may then use the results to finish executing the fstatvfsdev( ) command.

Hence, separating command component instructions that are specific to particular hardware, hardware configurations, or file system(s) from the command structure and storing the component instructions in an executable file in a suitable data structure enables commands to be implemented in a modular fashion. A command or library 164 can invoke the services of a daemon, such as daemon 166, to search the data structure to locate and execute the command component instructions that are specific to particular hardware, hardware configurations, file system(s) or volume manager(s), and other variable kernel components, and to return the resulting information to the command or library 164.

In addition, separating command component instructions that are specific to particular hardware, hardware configurations, file system(s), volume manager(s), or other variable kernel components from the command structure and storing the component instructions in an executable file in suitable data structure enables new components to be installed without requiring changes to library 164 or statically-linked commands. When a new component is installed, the new component can supply one or more executable files to the directory. Further, loadable components may be installed on a running system without rebooting, patching or otherwise disrupting library 164 or other command code.

While the examples described above focused on the fstatvfsdev( ) command structure, it will be appreciated that the principles described herein are equally applicable to virtually any commands that include component instructions that are specific to particular hardware, hardware configurations, or file system(s), volume manager(s) or other kernel components.

Select embodiments discussed herein (such as those discussed with reference to FIG. 1) may include various operations. These operations may be performed by hardware components or may be embodied in machine-executable instructions, which may in turn be utilized to cause a general-purpose or special-purpose processor, or logic circuits programmed with the instructions to perform the operations. Alternatively, the operations may be performed by a combination of hardware and software.

The various components and functionality described herein are implemented with a number of individual computers. FIG. 5 shows components of typical example of such a computer, referred by to reference numeral 500. The components shown in FIG. 5 are only examples, and are not intended to suggest any limitation as to the scope of the functionality of the invention; the invention is not necessarily dependent on the features shown in FIG. 5.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions, programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 5, the components of computer 500 may include, but are not limited to, a processing unit 504, a system memory 506, and a system bus 508 that couples various system components including the system memory 506 to the processing unit 504. The system bus 508 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 500 typically includes a variety of computer-readable media. Computer-readable media can be any available media that can be accessed by computer 500 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network, fiber optic networks, or direct-wired connection and wireless media such as acoustic, RF, infrared and other wireless media. Combinations of any of the above should also be included within the scope of computer readable media.

The system memory 506 includes computer storage media in the form of volatile and/or nonvolatile memory such as read only memory (ROM) 510 and random access memory (RAM) 512. A basic input/output system 514 (BIOS), containing the basic routines that help to transfer information between elements within computer 500, such as during start-up, is typically stored in ROM 510. RAM 512 typically contains data and/or program modules that are immediately accessible to and/or presently being operated on by processing unit 504. By way of example, and not limitation, FIG. 5 illustrates operating system 516, application programs 518, other software components 520, and program data 522.

The computer 500 may also include other removable/non-removable, volatile/nonvolatile computer storage media. By way of example only, the computer system of FIG. 5 may include a hard disk drive 524 that reads from or writes to non-removable, nonvolatile magnetic media, a magnetic disk drive 526 that reads from or writes to a removable, nonvolatile magnetic disk 528, and an optical disk drive 530 that reads from or writes to a removable, nonvolatile optical disk 532 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 524 is typically connected to the system bus 508 through a non-removable memory interface such as data media interface 534, and magnetic disk drive 526 and optical disk drive 530 are typically connected to the system bus 508 by a removable memory interface.

The drives and their associated computer storage media discussed above and illustrated in FIG. 5 provide storage of computer-readable instructions, data structures, program modules, and other data for computer 500. In FIG. 5, for example, hard disk drive 524 is illustrated as storing operating system 516′, application programs 518′, software components 520′, and program data 522′. Note that these components can either be the same as or different from operating system 516, application programs 518, software components 520, and program data 522. Operating system 516, application programs 518, other program modules 520, and program data 522 are given different numbers here to illustrate that, at a minimum, they are different copies. A user may enter commands and information into the computer 500 through input devices such as a keyboard 536 and pointing device 538, commonly referred to as a mouse, trackball, or touch pad. Other input devices (not shown) may include a microphone 540, joystick, game pad, satellite dish, scanner, or the like. These and other input devices are often connected to the processing unit 504 through an input/output (I/O) interface 542 that is coupled to the system bus, but may be connected by other interface and bus structures, such as a parallel port, game port, or a universal serial bus (USB). A monitor 544 or other type of display device is also connected to the system bus 506 via an interface, such as a video adapter 546. In addition to the monitor 544, computers may also include other peripheral output devices (e.g., speakers) and one or more printers 570, which may be connected through the I/O interface 542.

The computer may operate in a networked environment using logical connections to one or more remote computers, such as a remote computing device 550. The remote computing device 550 may be a personal computer, a server, a router, a network PC, a peer device or other common network node, and typically includes many or all of the elements described above relative to computer 500. The logical connections depicted in FIG. 5 include a local area network (LAN) 552 and a wide area network (WAN) 554. Although the WAN 554 shown in FIG. 5 is the Internet, the WAN 554 may also include other networks. Such networking environments are commonplace in offices, enterprise-wide computer networks, intranets, and the like.

When used in a LAN networking environment, the computer 500 is connected to the LAN 552 through a network interface or adapter 556. When used in a WAN networking environment, the computer 500 typically includes a modem 558 or other means for establishing communications over the Internet 554. The modem 558, which may be internal or external, may be connected to the system bus 508 via the I/O interface 542, or other appropriate mechanism. In a networked environment, program modules depicted relative to the computer 500, or portions thereof, may be stored in the remote computing device 550. By way of example, and not limitation, FIG. 5 illustrates remote application programs 560 as residing on remote computing device 550. It will be appreciated that the network connections shown are exemplary and other means of establishing a communications link between the computers may be used.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method of executing a command in a computing system, comprising:
receiving, at a message interface associated with a daemon executing on the computing system, a service request identifying a command for execution;
in response to the service request, executing one or more executable files related to the command for execution; and
returning an output resulting from executing the one or more executable files related to the command for completing execution.

2. The method of claim 1, further comprising:
executing the command; and
in response to the command execution, transmitting a service request from a command library to the daemon.

3. The method of claim 1, wherein receiving, at the message interface associated with the daemon executing on the computing system, a service request identifying a command for execution comprises:
extracting from the service request a descriptor that identifies the one or more of the executable files related to the command for execution.

4. The method of claim 3, further comprising:
searching a hierarchical directory structure for the one or more executable files corresponding to the descriptor; and
executing the one or more executable files corresponding to the descriptor located in the hierarchical directory.

5. The method of claim 1, wherein returning an output resulting from executing the one or more executable files related to the command for execution comprises returning an error message.

6. The method of claim 1, wherein returning an output resulting from executing the one or more executable files related to the command for execution comprises returning a data structure comprising information to facilitate completion of execution of the command.

7. The method of claim 1, wherein:
the command for execution requires one or more component-specific parameters; and
the one or more executable files retrieves the one or more component-specific parameters from a hardware component, a file system, volume manager or other data structure and passes the parameters to the daemon; and
the daemon passes the one or more of the parameters to an interface for use by the command for completing execution.

8. A computing system, comprising:
one or more processors;
a memory module communicatively connected to the one or more processors and comprising logic instructions which, when executed on the one or more processors configure the one or more processors to:
receive, at a message interface associated with a daemon executing on the computing system, a service request identifying a command for execution;
in response to the service request, execute one or more executable files related to the command for execution; and
return an output resulting from executing the one or more executable files related to the command for completing execution.

9. The computing system of claim 8, further comprising logic instructions which, when executed on the one or more processors configure the one or more processors to:
execute a command; and
in response to the command execution, transmit a service request from a command library to the daemon.

10. The computing system of claim 8, further comprising logic instructions which, when executed on the one or more processors configure the one or more processors to extract from the service request a descriptor that identifies the one or more executable files related to the command for execution.

11. The computing system of claim 8, further comprising logic instructions which, when executed on the one or more processors configure the one or more processors to:
search a hierarchical directory structure for the one or more executable files corresponding to the descriptor; and
execute the one or more executable files corresponding to the descriptor located in the hierarchical directory.

12. The computing system of claim 8, further comprising logic instructions which, when executed on the one or more processors configure the one or more processors to return an error message generated by the one or more executable files.

13. The computing system of claim 8, further comprising logic instructions which, when executed on the one or more processors configure the one or more processors to return a data structure comprising information to facilitate completion of execution of the command.

14. The computing system of claim 8, wherein:
the command for execution requires one or more component-specific parameters; and
the one or more executable files retrieves the one or more component-specific parameters from a file system, volume manager or other variable hardware or kernel component and passes the parameters to the daemon; and
the daemon passes the one or more component-specific parameters to an interface for use by the command for completing execution.

15. A computer program product stored on a computer-readable medium comprising logic instructions which, when executed on a processor, configure the processor to:
receive a service request identifying a command for execution on the processor;
in response to the service request, execute one or more executable files related to the command for execution; and
return an output resulting from executing one or more executable files related to the command for completing execution.

16. The computer program product of claim 15, further comprising further comprising logic instructions which, when executed on the processor configure the processor to:
execute a command from a command library; and
in response to the command execution, transmit a service request from the command library to the daemon.

17. The computer program product of claim 15, further comprising logic instructions which, when executed on the processor configure the processor to extract from the service request a descriptor that identifies the one or more executable files related to the command for execution.

18. The computer program product of claim 15, further comprising logic instructions which, when executed on the processor configure the processor to:
search a hierarchical directory structure for one or more executable files corresponding to the descriptor; and
execute the one or more executable files corresponding to the descriptor located in the hierarchical directory.

19. The computer program product of claim 15, further comprising logic instructions which, when executed on the processor configure the processor to return an error message generated by the one or more executable files.

20. The computer program product of claim 15, further comprising logic instructions which, when executed on the processor configure the processor to return a data structure comprising information to facilitate completion of execution of the command.

21. The computer program product of claim 15, wherein:
the command for execution requires one or more component-specific parameters; and
the one or more executable files retrieves the one or more component-specific parameters from a file system and passes the parameters to the daemon; and
a daemon passes the one or more component-specific parameters to an interface for use by the command for completing execution.

22. A system for daemon assisted command execution, comprising:
a processor;
means for receiving one or more commands executable on the processor;
means for associating one of the commands with a corresponding command component instruction stored in a separate memory module that are specific to a hardware device, a hardware configuration, a file system, volume manager or other variable kernel component; and
means for executing the corresponding command component instruction.

23. The system of claim 22, wherein the means for associating the command with the corresponding command component instruction stored in a separate memory module comprises a daemon.

24. The system of claim 23, wherein the means for receiving one or more commands executable on the processor comprises a message interface that communicates with the daemon using an interprocess communication method.

25. The system of claim 23, wherein:
a command library transmits a command identifier to the daemon;
the daemon searches a directory for a command instruction corresponding to the command identifier; and
the daemon executes one or more command instructions corresponding to the command identifier.

26. The system of claim 25, wherein the daemon returns to the message interface a result of executing one or more command instructions corresponding to the command identifier.
